(19) United States
(12) Patent Application Publication
(10) Pub. No.: US 2002/0070293 A1
(43) Pub. Date: Jun. 13, 2002

(54) Shower filtration skin care device

(76) Inventor: Shih Ti Ti, Taichung Hsien (TW)

Correspondence Address: Harrison & Egbert, 412 Main Street, 7th Floor, Houston, TX, 77002, US

(21) Appl. No.: 09/731,186

(22) Filed: Dec. 7, 2000

(51) Int. Cl. B05B 1/14; B05B 1/30

(52) U.S. Cl. 239/317; 239/553; 239/575

(57) ABSTRACT

This invention is a shower filtration skin care device. Its main shell is composed of upper and lower portions that lock together to form a single piece. This locked piece is constructed so as to join the threaded tube at the bottom of an existing hand-held spray nozzle and the threaded orifice at the top of the nozzle hose, forming a suitable space within the main shell to contain the filter body or filter seat with a built-in filter body. In addition, this space may also contain a secondary shell holding a skin care product. When the above elements are so assembled, the quality of water exiting the hand-held spray nozzle will be improved. Furthermore, when the hand-held spray nozzle is used to wash one's body, one's skin will simultaneously receive the therapeutic benefits of the skin care products contacting it.

### BACKGROUND OF THE INVENTION

1. Field of the Invention

This invention relates to a type of shower filtration skin care device, and in particular refers to a special structural assembly that consists of a main shell that is used in conjunction with a hand-held spray nozzle and contains an internal filter body, filter seat containing a filter body, or a secondary shell containing a skin care product. This invention can cause the quality of water exiting the hand-held spray nozzle to be improved. Furthermore, when the hand-held spray nozzle is used to wash one's body, one's skin will simultaneously receive the therapeutic benefits of the skin care products contacting it.

2. Description of Related Art

In light of the fact that a hand-held spray nozzle has become a more necessary apparatus when washing one's body, and the use of a hand-held spray nozzle to spray water to rinse one's body is the fastest, most convenient, and most water-saving bathing method, bathtubs installed in bathrooms exist in name only and are not commonly used by people. Firstly, people's daily habits have changed with the arrival of a business-oriented, scientific living environment; secondly, people's lives have been made busy by the industrial/commercial society they live in; and thirdly, people are accustomed to adopting the fastest, most convenient, and simplest approach to all matters, and to bathe by soaking in a bathtub is, in contrast, obviously time-consuming and inconvenient. For instance, because dirt tends to accumulate within a bathtub, it is necessary to first scrub the inside of the bathtub clean before each time one takes a bath, and it is also necessary to wait until the water inside the bathtub reaches a level suitable for soaking before beginning the bath. The amount of time consumed by the whole bathing process is enough to discourage people from taking regular soaking baths. When some means of ladling the water is used to wash one's body instead of a hand-held spray nozzle, the bath is obviously extremely inconvenient and has the defect of rinsing one's body with unclean water. In addition, using a large quantity of water to wash one's body in a bathtub also has the shortcomings of wasting water resources and incurring greater water costs.

The above explanation tells us that the use of a hand-held spray nozzle to bathe is clearly superior to bathing in a bathtub in terms of speed, convenience, cleanliness, and water conservation. The probability and frequency of people using a hand-held spray nozzle is therefore far greater than the likelihood they will soak in a tub. Moreover, the use of a hand-held spray nozzle to wash the entire body, rather than bathing by soaking in a tub, is becoming increasing universal, and the hand-held spray nozzle has thus become the chief piece of apparatus used in bathing.

Nevertheless, pollution of the environment is becoming an increasing severe problem, and the earth's water resources are suffering from acute pollution in many places. For this reason, after water purification plants have taken polluted water, they must perform a manifold process of disinfection, sedimentation, and filtration before they can provide relatively clean tap water through a piping system for household use. The purification process at a water purification plant therefore includes the use of such chemical substances as chlorine or tribasic methyl to clean the water. In fact it is universally known that chlorine is added to sterilize water. As far as drinking water is concerned, today reverse osmosis devices, multiple filtration devices, and electrolytic apparatus are used to eliminate residual chemical toxins, bacteria, and foreign materials as much as possible from the water, avoiding the health risk of drinking contaminated water. To date, people are only willing to accept drinking water that has been purified by filtration.

Residual toxins in tap water, as well as the foreign materials and bacteria the water may pick up while flowing through pipes, will make direct contact with a person's skin and hair while that person is bathing, causing contamination and damage. This damage will be particularly severe in the case of women's delicate skin and hair. In addition, the cleanliness of the water is especially important when a women bathes during her menstrual period.

Addressing the above shortcomings and needs, the industry has already developed several types of hand-held spray nozzles with a filtration function. Although these types of hand-held spray nozzles can improve the quality of the shower water, they still suffer from major defects; consequently this kind of filtration-type hand-held spray nozzle has been unable to win universal acceptance. For this type of hand-held spray nozzle to achieve its filtration function, it is necessary to modify the internal construction of a commonly-used hand-held spray nozzle so that a filtration material can be installed. This, however, makes it impossible to maintain compatibility with existing household hand-held spray nozzles, forcing users to purchase a whole new hand-held spray nozzle incorporating a filtration function, remove the old hand-held spray nozzle from their shower, and install the new nozzle. Forcing the user to discard or put aside the existing household hand-held spray nozzle causes waste. Due to the special internal construction of the new hand-held spray nozzle, it is necessary to manufacture a whole new spray nozzle and filtration assembly, which is very costly and makes this type of hand-held spray nozzle extremely expensive on the market. The high price of this type of nozzle thus greatly reduces consumer acceptance. These are the primary reasons that existing hand-held spray nozzles with a filtration function cannot achieve widespread use.

### BRIEF SUMMARY OF THE INVENTION

A goal of this invention is to provide a shower filtration skin care device that can be installed below a hand-held spray nozzle and which solves the above-mentioned problems that occur during bathing.

Another goal of this invention is to provide a shower filtration skin care device that can be used in conjunction with the existing hand-held spray nozzle in ordinary household bathrooms, that does not require the replacement of or any structural or external modifications to the existing spray nozzle, that can add a filtration function to an existing hand-held spray nozzle, that can improve the quality of the shower water exiting the spray nozzle, and that can prevent contamination of or damage to skin or hair while showering.

Yet another goal of this invention is to provide a shower filtration skin care device that will enable one's skin to enjoy the therapeutic benefits of skin care products while showering using a hand-held spray nozzle, and consequently cause the spray nozzle to simultaneously provide skin care beauty benefits during showering.

Yet another goal of this invention is to provide a shower filtration skin care device that is easy to install and use, and whose filtration and skin care benefits can be conveniently confirmed by visual inspection.

Yet another goal of this invention is to provide a shower filtration skin care device that is inexpensive to manufacture, and consequently can be sold for a much lower price, while still improving the quality of water from existing hand-held spray nozzles, thereby increasing consumer willingness to purchase the device and encouraging spread of its use.

Yet another goal of this invention is to provide a shower filtration skin care device that is very light and easy to carry. Due to these features, a person who is on a trip or traveling abroad may easily carry the device and freely install it on a hand-held spray nozzle found in a hotel room, enabling that person to improve the quality of the shower water, while simultaneously receiving the therapeutic benefits of skin care products when using the spray nozzle to shower.

### BRIEF DESCRIPTION OF THE SEVERAL VIEWS OF THE DRAWINGS

To help your esteemed inspectors to further understand and become familiar with this invention's goals, characteristics, and benefits, the following detailed figure explanations are provided.

FIG. 1 is perspective view of the present invention's main shell containing the filter body and attached to the hand-held spray nozzle and nozzle hose.

FIG. 2 is an exploded perspective view of the present invention's main shell containing the filter body and attached to the hand-held spray nozzle and nozzle hose.

FIG. 3 is a cross-sectional view of the present invention's main shell containing the filter body and attached to the hand-held spray nozzle and nozzle hose while water is entering.

FIG. 4 is a perspective view of an alternative embodiment of the invention's main shell containing the filter seat and attached to the hand-held spray nozzle and nozzle hose.

FIG. 5 is an exploded perspective view of this second embodiment's main shell containing the filter seat and attached to the hand-held spray nozzle and nozzle hose.

FIG. 6 is a cross-sectional view of this second embodiments main shell containing the filter seat and attached to the hand-held spray nozzle and nozzle hose while water is entering.

FIG. 7 is perspective view of another alternative embodiment of the invention's main shell containing the secondary shell and attached to the hand-held spray nozzle and nozzle hose.

FIG. 8 is an exploded sectional view of this third embodiment's main shell containing the secondary shell and attached to the hand-held spray nozzle and nozzle hose.

FIG. 9 is a cross-sectional view of this third embodiment's main shell containing the secondary shell and attached to the hand-held spray nozzle and nozzle hose.

FIG. 9-1 is an exploded cross-sectional view of a continuation of FIG. 9 of this third embodiment.

FIG. 10 is a cross-sectional view of this third embodiment's main shell containing the secondary shell while water is entering.

FIG. 11 is a perspective view of still another embodiment of the invention's main shell containing the filter seat and attached to the hand-held spray nozzle and nozzle hose.

FIG. 12 is an exploded perspective view of the fourth embodiment's main shell containing the filter seat and secondary shell and attached to the hand-held spray nozzle and nozzle hose.

FIG. 13 is a cross-sectional view of this fourth embodiment's main shell containing the filter seat and secondary shell and attached to the hand-held spray nozzle and nozzle hose.

FIG. 13-1 is an exploded cross-sectional view of a continuation of FIG. 14 of this fourth embodiment.

FIG. 14 is a cross-sectional view of this fourth embodiment's main shell containing the filter seat and secondary shell while water is entering.

FIG. 15 is a cross-sectional view of another relatively optimal implementation of this invention's secondary shell.

FIG. 16 is a cross-sectional view of yet another relatively optimal implementation of this invention's secondary shell.

FIG. 17 is a cross-sectional view of yet another relatively optimal implementation of this invention's secondary shell.

FIG. 18 is a cross-sectional view of yet another relatively optimal implementation of this invention's secondary shell.

FIG. 19 is a cross-sectional view of yet another relatively optimal implementation of this invention's secondary shell.

### DETAILED DESCRIPTION OF THE INVENTION

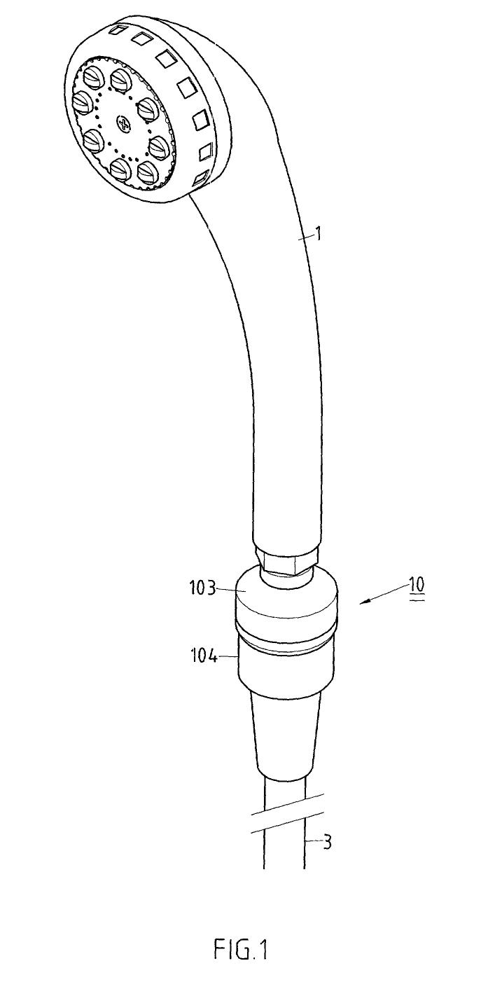

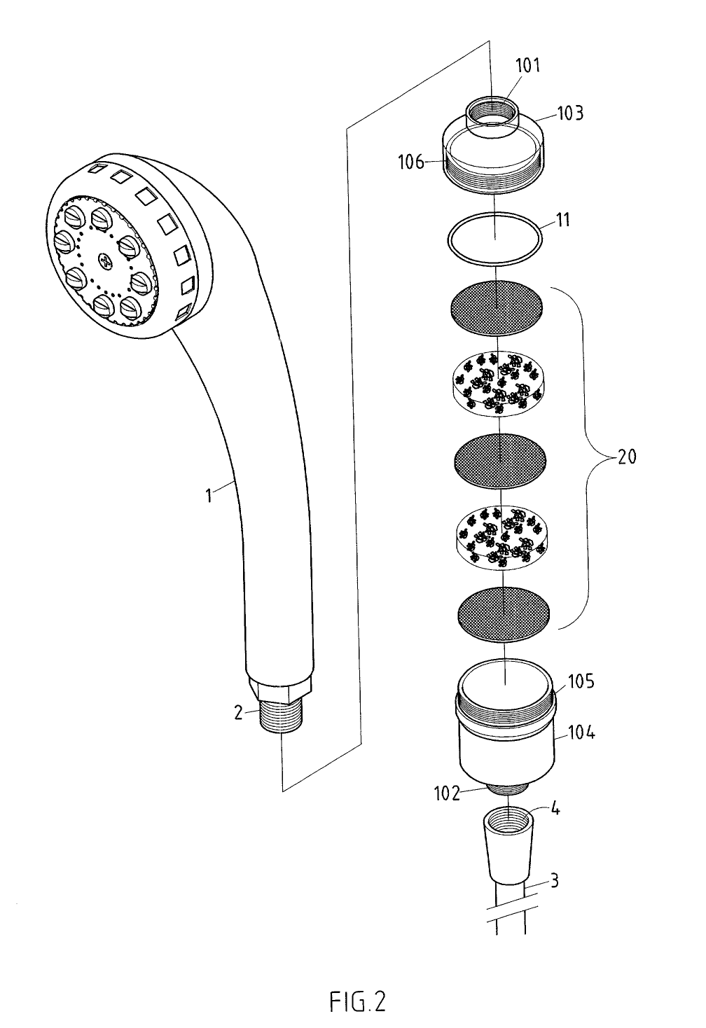

The present invention is seen in FIGS. 1, 2, and 3. This invention provides a shower filtration skin care device formed by a single locked portion (101) (102) consisting of the top and bottom of main shell (10). The locked portion (101) (102) can be conjoined to the threaded tube portion (2) at the bottom of an existing hand-held spray nozzle (1) and the threaded orifice (4) at the top end of a nozzle hose (3). This causes the interior of main shell (10) to form an appropriate space for the installation of filter body (20), and also causes the flow of water to pass through main shell (10) and be filtered in filter body (20), after which the water is sprayed through hand-held spray nozzle (1).

In this type of shower filtration skin care device, the main shell (10) is optimally composed of a two-section body, which is to say that the main shell (10) is divided into an upper and lower cover (103) (104). The junction between the upper and lower cover (103) (104) maybe either tightly bonded or in the form of locked threaded portions (105) (106) in conjunction with a gasket (11). This design prevents leakage and outflow, while facilitating the installation of filter body (20) in the main shell (10).

In one type of shower filtration skin care device, the filter body (20) may consist of filter cotton, a filter mesh, or a non water-soluble granular or lump-type purification material (such as activated carbon, zeolite, maifan stone, or sulfite, etc.) that can sterilize, deodorize, or soften the water.

There are many uses and benefits of the aforementioned implementation of this invention.

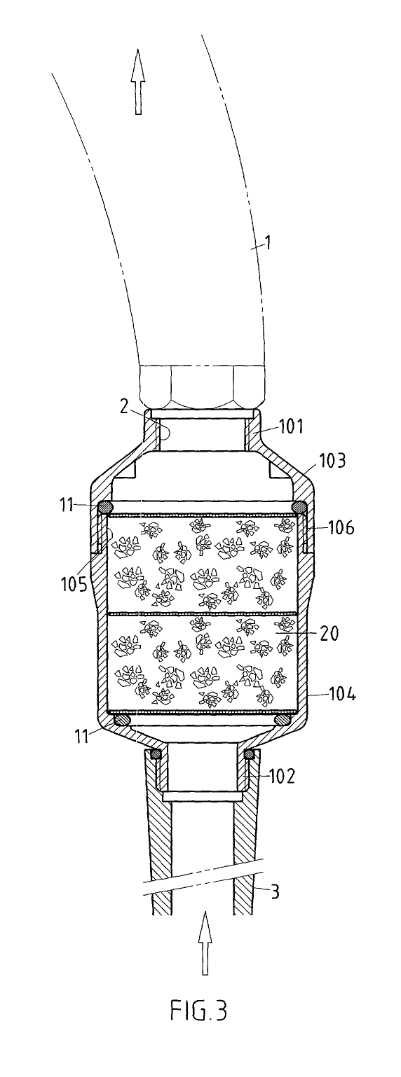

First, the invention is seen in FIG. 3. The filter body (20) is installed in the main shell (10), and the locking portions (101) (102) at the top and bottom of main shell (10) are used separately to attach the unit to the threaded tube portion (2) at the bottom of an existing hand-held spray nozzle (1) and the threaded orifice (4) at the top end of a nozzle hose (3). Water passing through the filter cotton, filter mesh, activated carbon, zeolite, maifan stone, or sulfite in filter body (20) is filtered, sterilized, deodorized, or degassed. This process improves the quality of water sprayed using spray nozzle (1), which achieves the practical results of preventing damage to or contamination of human skin or hair.

Second, the filter body (20) is installed within main shell (10) to form an independent component. The top and bottom locking portions (101) (102) of main shell (10) are separately used to connect to the threaded tube portion (2) at the bottom of an existing hand-held spray nozzle (1) and the threaded orifice (4) at the top end of a nozzle hose (3). This makes it unnecessary to modify in any way the structure or exterior of an existing hand-held spray nozzle (1), and likewise makes it easy to use an existing hand-held spray nozzle (1) in conjunction with this invention's main shell (10) and filter body (20) to give the existing bathroom hand-held spray nozzle (1) a filtration function.

Third, because this invention makes it unnecessary to modify in any way the structure or exterior of an existing hand-held spray nozzle (1), there is therefore no need to manufacture a new hand-held spray nozzle (1) for use in conjunction with this invention. In addition, the user need not purchase a new spray nozzle to use in conjunction with this invention. This invention is therefore inexpensive to manufacture; and greatly reducing sales price will encourage consumers to purchase this invention and make its use much more widespread.

Fourth, because the main shell (10) is attached to the lower end of an existing hand-held spray nozzle (1), there are no mounting space restrictions, and the assembly is located far from high temperatures at the hot/cold mixing faucet. This assembly is easy to install and use, and offers the practical benefit of not being readily damaged due to high-temperature deformation.

Fifth, because the main shell (10) can be freely attached to the lower end of a hand-held spray nozzle (1), and because the main shell (10) is light, compact, and easy to carry, a person who is traveling abroad or staying at a hotel may freely attach main shell (10) to a hotel hand-held spray nozzle (1) for use. This achieves the benefit of improving the quality of the hotel shower water.

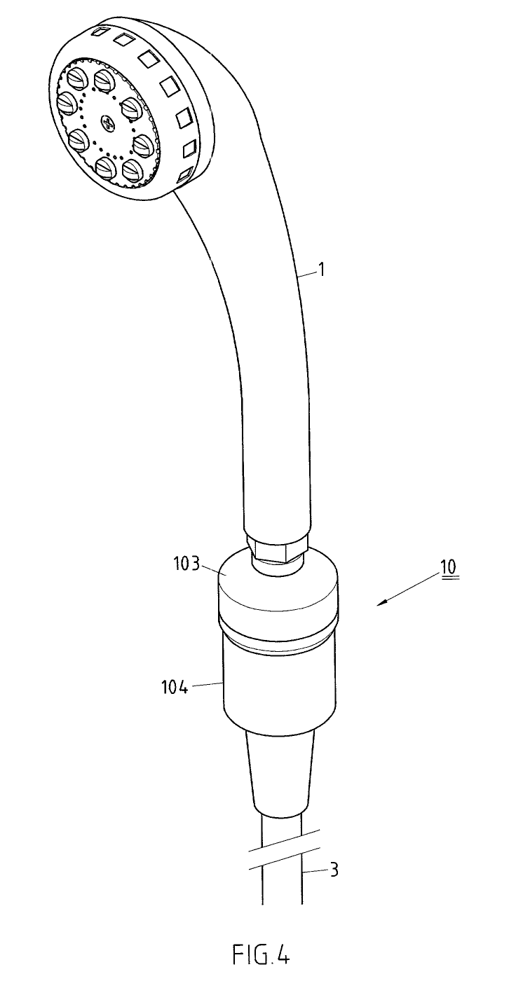

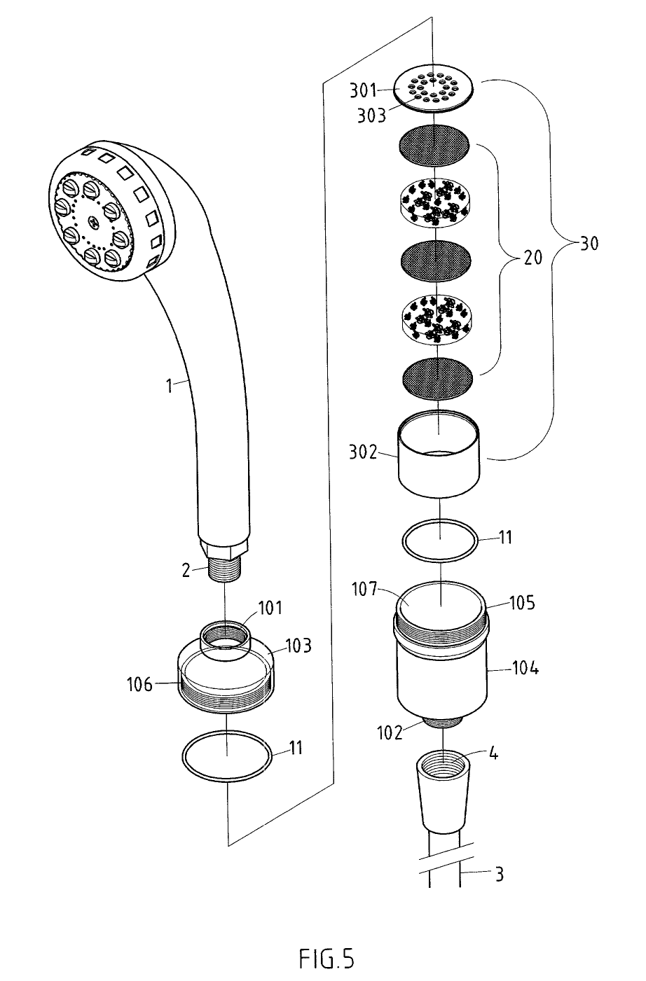

An alternative embodiment is shown in FIGS. 4, 5, and 6. The characteristics of one shower filtration skin care device derived from this second embodiment are that the locking portions (101) (102) formed at the top and bottom of main shell (10) can be attached to the threaded tube portion (2) at the bottom of an existing hand-held spray nozzle (1) and the threaded orifice (4) at the top end of a nozzle hose (3), that a filter seat (30) may be installed within main shell (10), and that a filter body (20) may be installed within the filter seat (30). After water flows through the interior of main shell (10) and passes through the filter body (20) within filter seat (30), it is sprayed out via hand-held spray nozzle (1).

In this second embodiment of shower filtration skin care device, the main shell (10) is composed of a two-stage body, which is to say that the main shell (10) is divided into an upper and lower cover (103) (104). The junction between the upper and lower cover (103) (104) may be locked by means of threaded portions (105) (106) in conjunction with a gasket (11). This design prevents leakage and outflow, while facilitating the installation of filter seat (30) in the main shell (10).

In this second embodiment of shower filtration skin care device, the filter seat (30) optimally has a two-section construction, which is to say that filter seat (30) consists of upper and lower covers (301) (302), and the upper and lower covers (301) (302) facilitate the installation of filter body (20). The junction between upper and lower covers (301) (302) may optimally be tightly bonded to form a watertight seal.

In this second embodiment of shower filtration skin care device, the filter body (20) may be filter cotton, a filter mesh, or a non water-soluble granular or lump-type purification material (such as activated carbon, zeolite, maifan stone, or sulfite, etc.) that can disinfect, deodorize, or soften the water.

In this second embodiment of shower filtration skin care device, the top and bottom of the filter seat (30) are in the form of numerous screen-covered water orifices (303).

In this second embodiment of shower filtration skin care device, the outer edge of the filter seat (30) presses tightly against the side wall (107) of the interior of the main shell (10).

There are may uses and benefits of the aforementioned implementation of this second embodiment.

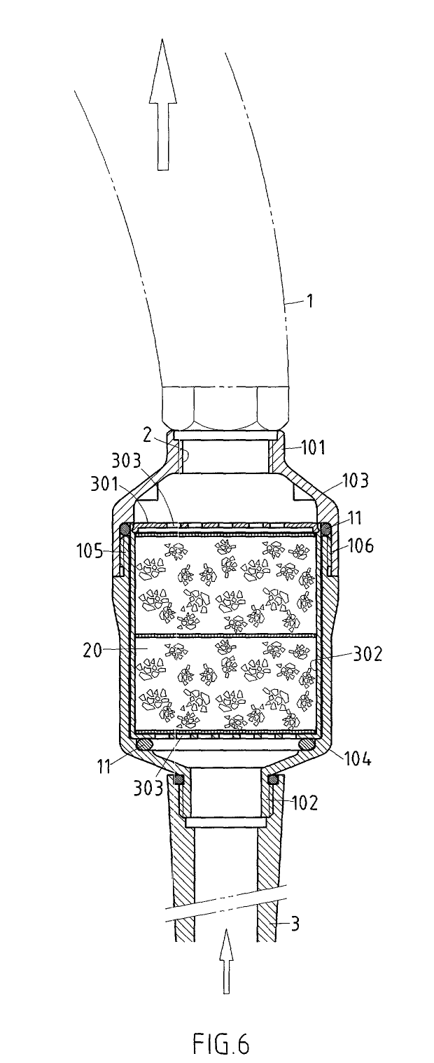

The second embodiment is seen in FIG. 6. A filter seat (30) is installed within the main shell (10), and the locking portions (101) (102) at the top and bottom of the main shell (10) are used separately to attach to the threaded tube portion (2) at the bottom of an existing hand-held spray nozzle (1) and the threaded orifice (4) at the top end of a nozzle hose (3). Water passing through filter body (20) (which may consist of filter cotton, filter mesh, activated carbon, zeolite, maifan stone, or sulfite) in filter seat (30) is filtered, sterilized, deodorized, or degassed, improving the quality of water sprayed from hand-held spray nozzle (1). This achieves the practical results of preventing damage to or contamination of human skin or hair.

Second, the main shell (10) contains a filter seat (30), and the filter seat (30) contains a filter body (20). Therefore when the filter seat (30) within the main shell (10) is dirty or malfunctioning, a new replacement filter seat (30) may be freely installed to insure that the water sprayed from hand-held spray nozzle (1) continues to be improved.

Third, filter seat (30) is installed within main shell (10) to form an independent component. The top and bottom locking portions (101) (102) of main shell (10) are separately used to connect to the threaded tube portion (2) at the bottom of an existing hand-held spray nozzle (1) and the threaded orifice (4) at the top end of a nozzle hose (3). This makes it unnecessary to modify in any way the structure or exterior of an existing hand-held spray nozzle (1), and likewise makes it easy to use an existing hand-held spray nozzle (1) in conjunction with this invention's main shell (10) and filter body (30) to give the existing bathroom hand-held spray nozzle (1) a filtration function.

Fourth, because this invention makes it unnecessary to modify in any way the structure or exterior of an existing hand-held spray nozzle (1), there is no need to manufacture a new hand-held spray nozzle (1) for use in conjunction with this invention. In addition, the user need not purchase a new spray nozzle to use in conjunction with this invention. This invention is therefore inexpensive to manufacture; and greatly reducing sales price will encourage consumers to purchase this invention and make its use much more widespread.

Fifth, because the main shell (10) is attached to the lower end of an existing hand-held spray nozzle (1), there are no mounting space restrictions, and the assembly is located far from high temperatures at the hot/cold mixing faucet. This assembly is easy to install and use, and offers the practical benefit of not being readily damaged due to high-temperature deformation.

Finally, because the main shell (10) can be freely attached to the lower end of a hand-held spray nozzle (1), and because the main shell (10) is light, compact, and easy to carry, a person who is traveling abroad or staying at a hotel may freely attach main shell (10) to a hotel hand-held spray nozzle (1) for use. This achieves the benefit of improving the quality of the hotel shower water.

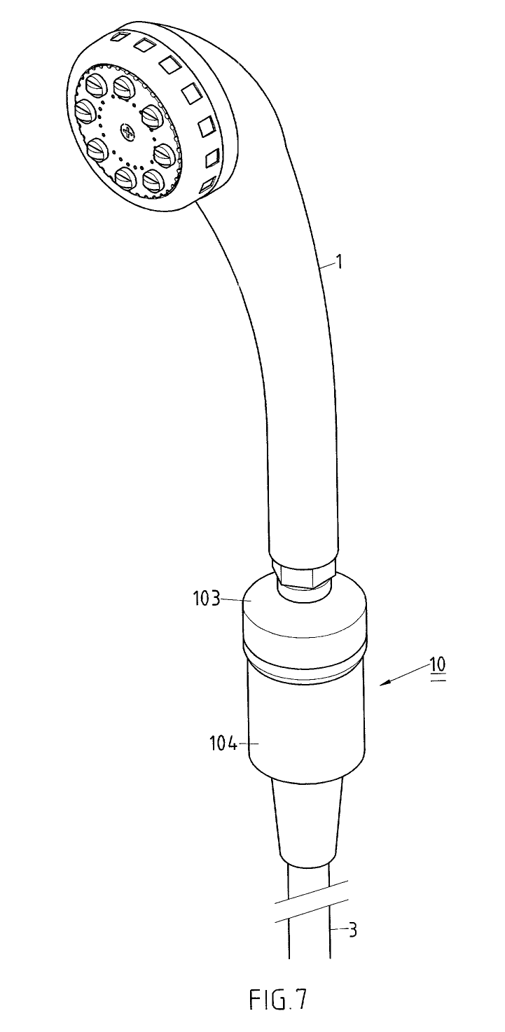

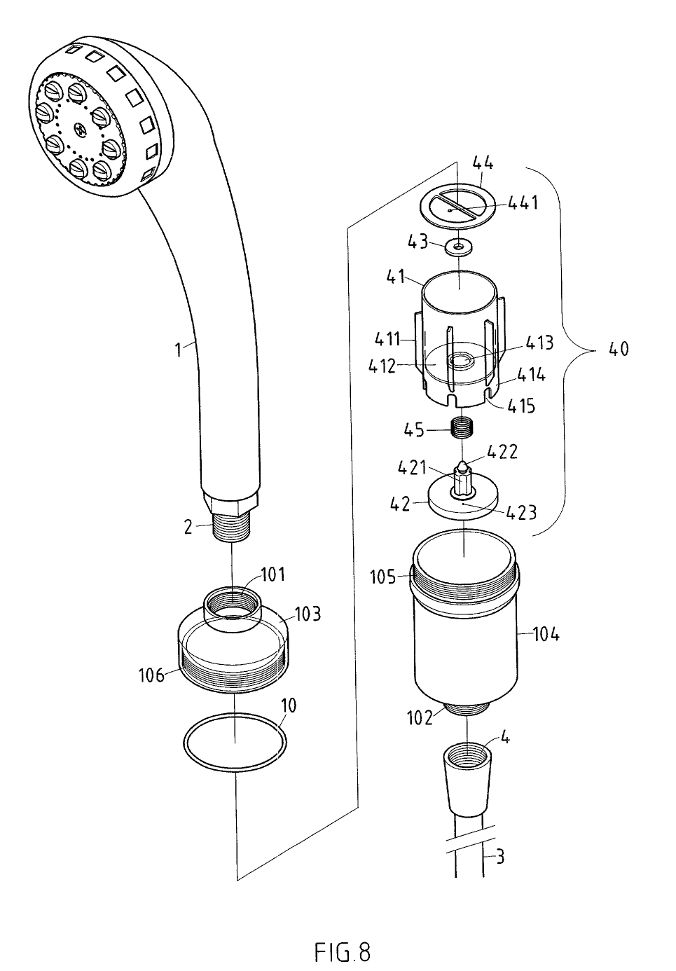

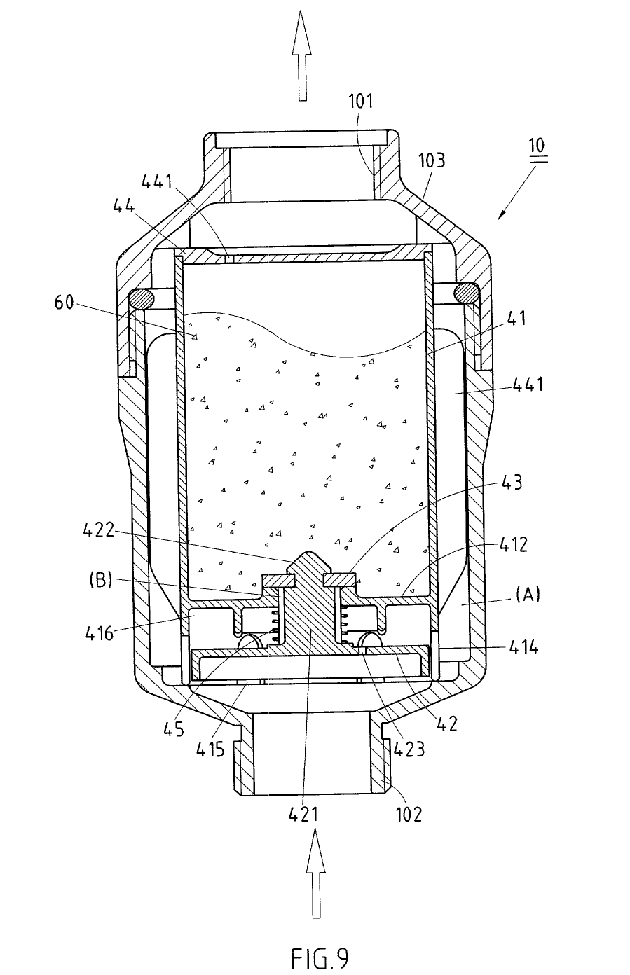

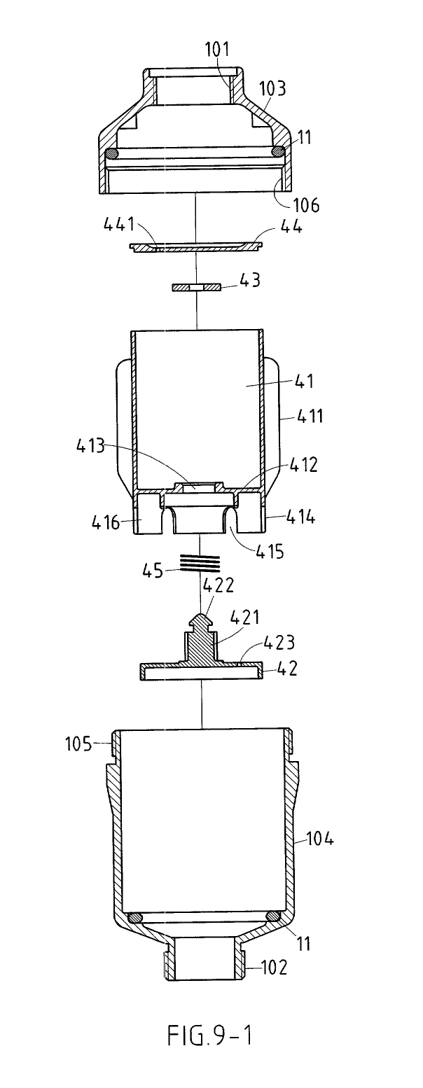

A third embodiment is shown is FIGS. 7, 8, 9, 9-1, and 10. The characteristics of one shower filtration skin care device derived from this third embodiment are that the locking portions (101) (102) formed at the top and bottom of main shell (10) can be attached to the threaded tube portion (2) at the bottom of an existing hand-held spray nozzle (1) and the threaded orifice (4) at the top end of a nozzle hose (3), that a secondary shell (40) may be installed within main shell (10), and that a skin care product (60) may be placed within the secondary shell (40). After water flows through the interior of main shell (10) and a portion passes through the secondary shell (40), it is sprayed out via hand-held spray nozzle (1).

In this third embodiment of shower filtration skin care device, the main shell (10) is optimally composed of a two-section body, which is to say that the main shell (10) is divided into an upper and lower cover (103) (104). The junction between the upper and lower cover (103) (104) may be locked using threaded portions (105) (106) in conjunction with a gasket (11). This design prevents leakage and outflow, while facilitating the installation of secondary shell (40) in the main shell (10).

In this third embodiment of shower filtration skin care device, the secondary shell (40) is composed of a hollow shell seat (41), a brake (42), a water stop flap (43), an upper cover (44), and a spring (45). The external wall of the shell seat (41) is constructed of numerous ribs (411) arranged at intervals. This insures that after the secondary shell (40) has been placed in the main shell (10), flow gaps (A) are maintained between the ribs (411) on the exterior of the shell seat and the interior wall of the main shell (10). A base plate (412) formed near the lower end of the shell seat (41) has a piercing hole (413) in its center. In addition, a base ring seat (414) of suitable length is located around the edge of shell seat (41) below base plate (412). Its edge contains numerous water orifices (415), forming a suitable space (416) between the base ring seat (414) and the base plate (412). The brake (42) is a round plate, the central top portion of which protrudes upward to form a column (421) of suitable height, the top of which forms a stop (422). This enables the outside of the column (421) to hold a spring (45). The brake (42) is mounted in the space (416) formed between the base ring seat (414) of the shell seat (41) and the bottom of the base plate (412), causing the column (421) to pass through the piercing hole (413) in the center of the base plate (412) and enter the interior of the shell seat (41). Furthermore, the center of water stop flap (43) is held in place by the stop (422) on the top of the column (421), insuring that the brake (42) is normally subject to the tension of spring (45), and causing column (421) to articulate with water stop flap (43) and seal the central piercing hole (413) in the top of base plate (412) on the shell seat (41). A suitable gap (B) is maintained between the outer diameter of column (421) and the inner wall of central piercing hole (413) in the base plate (412). A flow hole (423) perforates brake (42) near column (421). The upper cover (44) can cover the opening in the top of shell seat (41).

In this third embodiment of shower filtration skin care device, the skin care product (60) placed inside the secondary shell (40) may consist of water-soluble bath salts, hot springs essence, fragrant essence, emollient liquid, disinfectant, bath balls, bath bars, or perfume.

In this third embodiment of shower filtration skin care device, the surface of the upper cover (44) of secondary shell (40) consists of a water orifice (441).

There are many uses and benefits of the aforementioned implementation of this third embodiment.

First, when the user wishes to use shower skin care product (60) for skin care, beauty, or to eliminate skin aging, the user must first rotate open the upper cover (103) of main shell (10) and take off lower cover (104); the user may then open upper cover (44) of secondary shell (40) and insert skin care product (60) inside the shell seat (41), after which the tops of upper cover (103) and lower cover (104) are tightened by rotation. When water enters through the bottom of main shell (10), the water pressure will press the brake (42) upwards, and at this time most water flow will pass through the water orifices (415) on the side of the base ring seat (414) and the flow gaps (A) between the outside of the secondary shell (40) and the main shell (10), and will be sprayed out from the hand-held spray nozzle (1). However, a small portion of the water will pass through the flow hole (423) in brake (42) and the gap (B) between the piercing hole (413) in the center of base plate (412) and the column (421), and enter the interior of shell seat (41); this will cause the water flow to first mix with the skin care product (60) inside secondary shell (40), exit from the water orifice (441) in the upper cover (44) at the top of secondary shell (40), and afterwards be sprayed from spray nozzle (1) mixed with the rest of the water. This enables the user's skin to come in contact with skin care product (60) while showering using spray nozzle (1), thereby achieving the practical benefits of caring for one's skin, eliminating fatigue, disinfecting, and leaving a fragrance on one's skin while showering.

Second, when the user removes the entire secondary shell (40) and opens upper cover (44) to insert skin care product (60) in shell seat (41), the brake (42) will be subject to the tension of spring (45), causing column (421) to articulate with water stop flap (43) and seal the central piercing hole (413) in the top of base plate (412) on the shell seat (41). This will prevent the liquid skin care product (60) from leaking out of the bottom of secondary shell (40).

Third, because this invention enables the user's skin to come in contact with and enjoy the therapeutic benefits of shower skin care product (60) while showering using hand-held spray nozzle (1), it is an improvement on adding skin care product (60) to bathwater and soaking in the bathtub. It also is unnecessary to modify in any way the structure or exterior of an existing hand-held spray nozzle (1), allowing a hand-held spray nozzle (1) to be used during showering and simultaneously enabling the skin to contact a beneficial skin care product (60).

Fourth, the secondary shell (40) is installed within main shell (10) to form an independent component. The top and bottom locking portions (101) (102) of main shell (10) are separately used to connect to the threaded tube portion (2) at the bottom of an existing hand-held spray nozzle (1) and the threaded orifice (4) at the top end of a nozzle hose (3). This makes it unnecessary to modify in any way the structure or exterior of an existing hand-held spray nozzle (1), and likewise makes it easy to use an existing hand-held spray nozzle (1) to which this invention's main shell (10) together with the secondary shell (40) have been attached, enabling the existing bathroom hand-held spray nozzle (1) to provide the practical benefits of skin care, elimination of fatigue, disinfection, and leaving a fragrance on one's skin while showering.

Fifth, because this invention makes it unnecessary to modify in any way the structure or exterior of an existing hand-held spray nozzle (1), there is no need to manufacture a new hand-held spray nozzle (1) for use in conjunction with this invention. In addition, the user need not purchase a new spray nozzle to use in conjunction with this invention. This invention is therefore inexpensive to manufacture, and greatly reducing sales price will encourage consumers to purchase this invention and make its use much more widespread.

Finally, because the main shell (10) along with secondary shell (40) can be freely attached to the lower end of a hand-held spray nozzle (1), and because the main shell (10) is light, compact, and easy to carry, a user who is traveling abroad or staying at a hotel need not worry about whether the bathtub is clean, and may freely attach main shell (10) to a hotel hand-held spray nozzle (1) for use. The user thus need not use the bathtub, and can shower with the spray nozzle while achieving the practical benefits of skin care, elimination of fatigue, and leaving a fragrance on the skin.

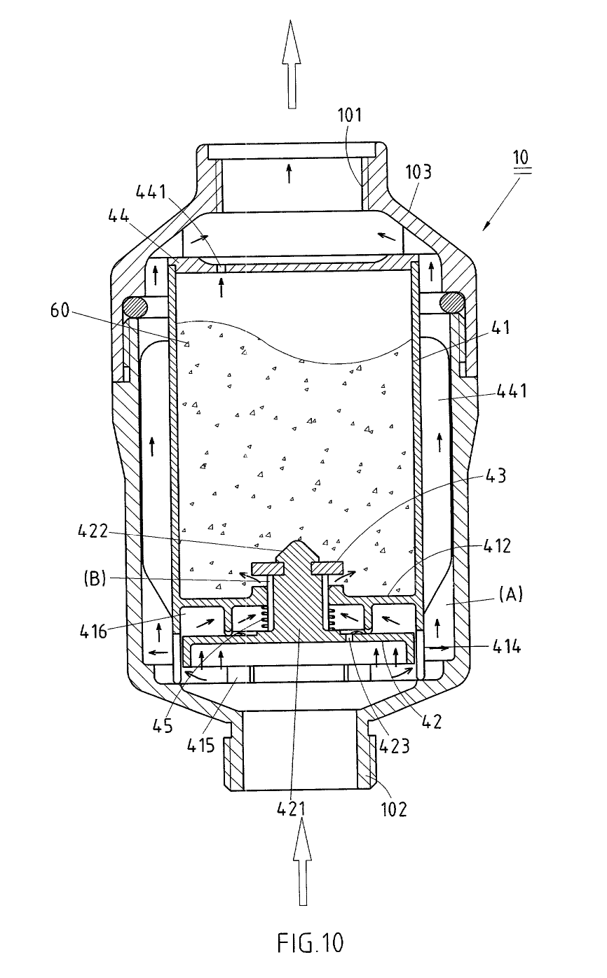

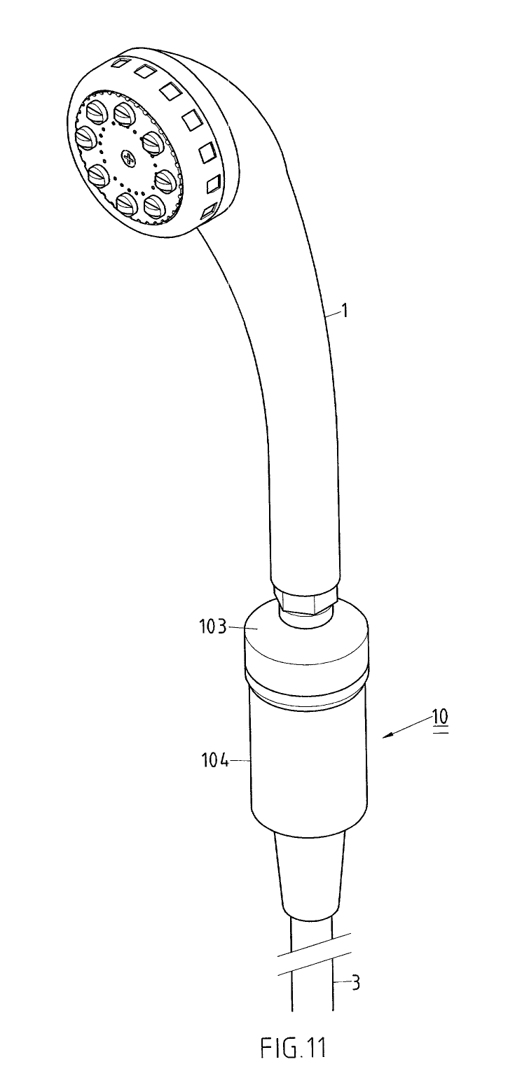

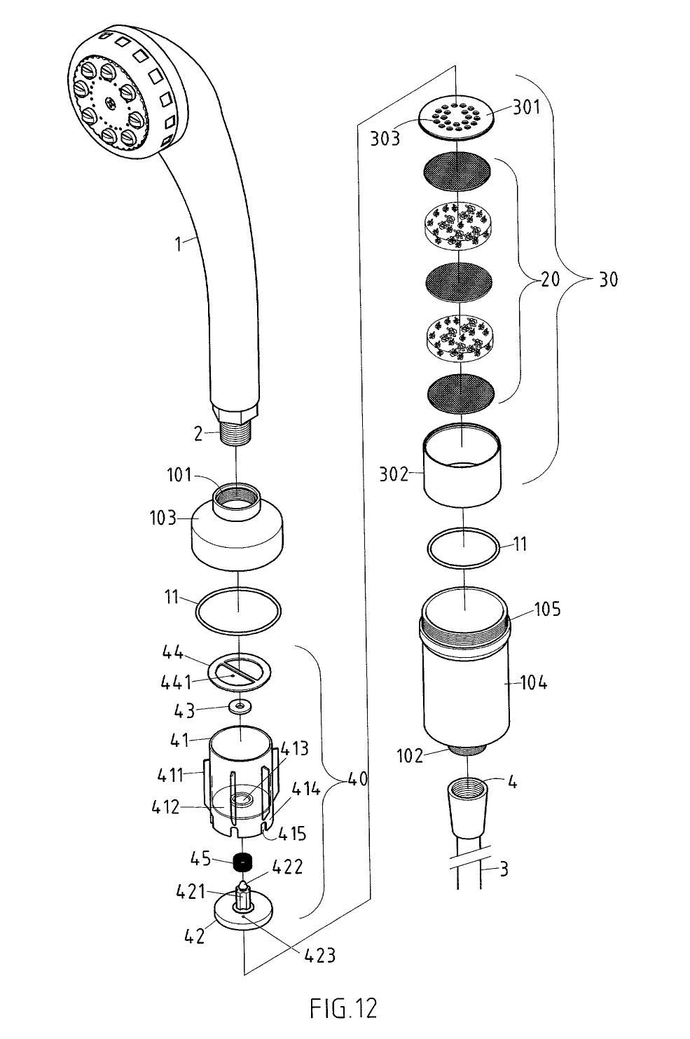

A fourth embodiment is shown in FIGS. 11, 12, 13, and 13-1. The characteristics of this fourth embodiment of shower filtration skin care device are that the locking portions (101) (102) formed at the top and bottom of main shell (10) can be attached to the threaded tube portion (2) at the bottom of an existing hand-held spray nozzle (1) and the threaded orifice (4) at the top end of a nozzle hose (3), that a filter seat (30) may be installed within main shell (10), and that a secondary shell (40) may be installed straddling filter seat (30). In this arrangement, after water flows through the interior of main shell (10) and passes through filter seat (30) and secondary shell (40), it is sprayed out via hand-held spray nozzle (1).

In this fourth embodiment of shower filtration skin care device, the main shell (10) is optimally composed of a two-section body, which is to say that the main shell (10) is divided into an upper and lower cover (103) (104). The junction between the upper and lower cover (103) (104) may be locked using threaded portions (105) (106) in conjunction with a gasket (11). This design prevents leakage and outflow, while facilitating the installation of filter seat (30) and secondary shell (40) in the main shell (10).

In this fourth embodiment of shower filtration skin care device, the filter seat (30) optimally has a two-section manner of attachment, which is to say that filter seat (30) consists of upper and lower covers (301) (302), and the upper and lower covers (301) (302) facilitate the installation of filter body (20). The junction between upper and lower covers (301) (302) may optimally be combined by tight coherence or liquid sealing. The surfaces of upper and lower covers (301) (302) are perforated by numerous screen-covered water orifices (303).

In this fourth embodiment of shower filtration skin care device, the secondary shell (40) consists of a hollow shell seat (41), a brake (42), a water stop flap (43), an upper cover (44), and a spring (45). The external wall of the shell seat (41) is constructed of numerous ribs (411) arranged at intervals. This insures that after the secondary shell (40) has been placed in the main shell (10), flow gaps (A) are maintained between the ribs (411) on the exterior of the shell seat and the interior wall of the main shell (10). A base plate (412) formed near the lower end of the shell seat (41) has a piercing hole (413) in its center. In addition, a base ring seat (414) of suitable length is located around the edge of shell seat (41) below base plate (412). Its edge contains numerous water orifices (415), forming a suitable space (416) between the base ring seat (414) and the base plate (412). The brake (42) is a round plate, the central top portion of which protrudes upward to form a column (421) of suitable height, the top of which forms a stop (422). This enables the outside of the column (421) to hold a spring (45). The brake (42) is mounted in the space (416) formed between the base ring seat (414) of the shell seat (41) and the bottom of the base plate (412), causing the column (421) to pass through the piercing hole (413) in the center of the base plate (412) and enter the interior of the shell seat (41). Furthermore, the center of water stop flap (43) is held in place by the stop (422) on the top of the column (421), insuring that the brake (42) is normally subject to the tension of spring (45), and causing column (421) to articulate with water stop flap (43) and seal the central piercing hole (413) in the top of base plate (412) on the hollow shell seat (41). A suitable gap (B) is maintained between the outer diameter of column (421) and the inner wall of central piercing hole (413) in the base plate (412). A flow hole (423) perforates brake (42) near column (421). The upper cover (44) can cover the opening in the top of shell seat (41).

In this fourth embodiment of shower filtration skin care device, the skin care product (60) placed inside the secondary shell (40) may consist of water-soluble bath salts, hot springs essence, fragrant essence, emollient liquid, disinfectant, bath balls, bath bars, or perfume.

In this fourth embodiment of shower filtration skin care device, the filter body (20) may consist of filter cotton, a filter mesh, or a non water-soluble granular or lump-type purification material (such as activated carbon, zeolite, maifan stone, or sulfite, etc.) that can sterilize, deodorize, or soften the water.

There are many uses and benefits of the aforementioned implementation of this fourth embodiment.

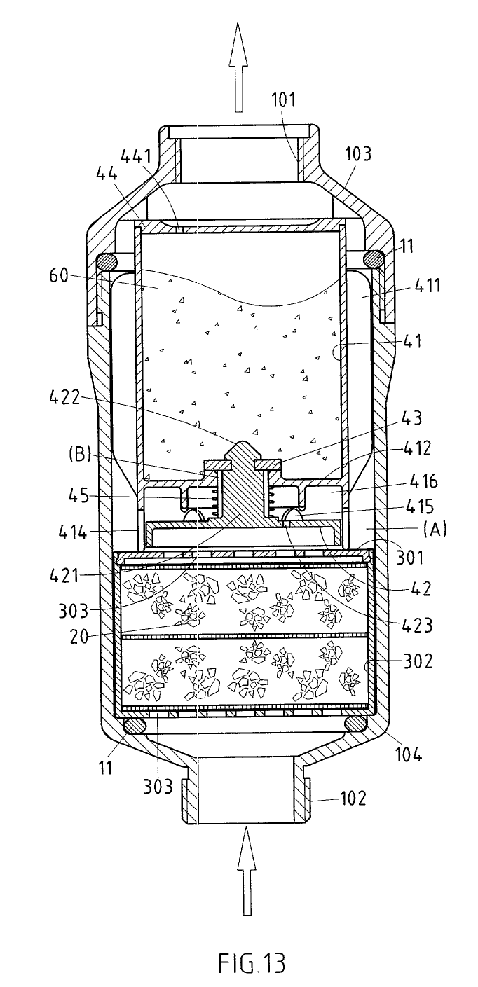

The fourth embodiment is seen in FIG. 14. The filter seat (30) is first placed in main shell (10), and secondary shell (40) then is placed in main shell (10) straddling filter seat (30). The interior of secondary shell (40) may be filled with a skin care product (60) (such as bath salts, hot springs essence, disinfectant, fragrant essence, etc.). In this arrangement, after secondary shell (40) is installed within main shell (10), and the upper cover (103) and lower cover (104) of main shell (10) are tightened by rotation, the base ring seat (414) will be tightly pressed against the filter seat (30) and unable to move, and the top of secondary shell (40) will be touching the inside of upper cover (103). At this time most water flow will pass through the water orifices (415) on the side of the base ring seat (414) and the flow gaps (A) between the outside of the secondary shell (40) and the main shell (10), and will be sprayed out from hand-held spray nozzle (1). However, a small portion of the water will pass through the flow hole (423) in brake (42) and the gap (B) between the piercing hole (413) in the center of base plate (412) and the column (421), and enter the interior of shell seat (41); this will cause the water flow to first mix with the skin care product (60) inside secondary shell (40), exit from the water orifice (441) in the upper cover (44) at the top of secondary shell (40), and afterwards be sprayed from spray nozzle (1) mixed with the rest of the water. This enables the user's skin to come in contact with skin care product (60) while showering using spray nozzle (1). Besides improving the quality of water sprayed from hand-held spray nozzle (1), this allows the user's skin to contact and derive therapeutic benefits from skin care product (60), protecting the skin from chemical pollutants and bacterial damage, and achieving the practical benefits of caring for one's skin, eliminating fatigue, disinfecting, and leaving a fragrance on one's skin.

Second, when the user removes the entire secondary shell (40) and opens upper cover (44) to insert skin care product (60) in shell seat (41), the brake (42) will be subject to the tension of spring (45), causing column (421) to articulate with water stop flap (43) and seal the central piercing hole (413) in the top of base plate (412) on the shell seat (41). This will prevent the liquid skin care product (60) from leaking out of the bottom of secondary shell (40).

Third, the filter seat (30) and secondary shell (40) are installed within main shell (10) to form an independent component. The top and bottom locking portions (101) (102) of main shell (10) are separately used to connect to the threaded tube portion (2) at the bottom of an existing hand-held spray nozzle (1) and the threaded orifice (4) at the top end of a nozzle hose (3). This makes it unnecessary to modify in any way the structure or exterior of an existing hand-held spray nozzle (1), and likewise makes it easy to attach this invention's main shell (10) together with the secondary shell (40) to an existing hand-held spray nozzle (1). A skin care product (60) is placed inside the secondary shell (40), which, besides improving the quality of water sprayed from hand-held spray nozzle (1), also enables an existing bathroom hand-held spray nozzle (1) to provide the practical benefits of skin care, elimination of fatigue, disinfection, and leaving a fragrance on one's skin while showering.

Fourth, because this invention makes it unnecessary to modify in any way the structure or exterior of an existing hand-held spray nozzle (1), there is therefore no need to manufacture a new hand-held spray nozzle (1) for use in conjunction with this invention. In addition, the user need not purchase a new spray nozzle to use in conjunction with this invention. This invention is therefore inexpensive to manufacture; by greatly reducing sales price, this will encourage consumers to purchase this invention and make its use much more widespread.

Fifth, because the main shell (10) is attached to the lower end of an existing hand-held spray nozzle (1), there are no mounting space restrictions, and the assembly is located far from high temperatures at the hot/cold mixing faucet. This assembly is easy to install and use, and offers the practical benefit of not being readily damaged due to high-temperature deformation.

Sixth, because this invention enables the user's skin to come in contact with and enjoy the therapeutic benefits of shower skin care product (60) while showering using hand-held spray nozzle (1), it is an improvement on adding skin care product (60) to bathwater and soaking in the bathtub. It also is unnecessary to modify in any way the structure or exterior of an existing hand-held spray nozzle (1), allowing a hand-held spray nozzle (1) to be used during showering and simultaneously enabling the skin to contact a beneficial skin care product (60).

Finally, because the main shell (10) can be freely attached to the lower end of a hand-held spray nozzle (1), and because the main shell (10) is light, compact, and easy to carry, a user who is traveling abroad or staying at a hotel need not worry about whether the bathtub is clean, and may freely attach main shell (10), together with filter seat (30) and secondary shell (40), to a hotel hand-held spray nozzle (1) for use. The user thus need not use the bathtub, and, by showering with hand-held spray nozzle (1), can improve the quality of the shower water while achieving the practical benefits of skin care, elimination of fatigue, disinfection, and leaving a fragrance on the skin.

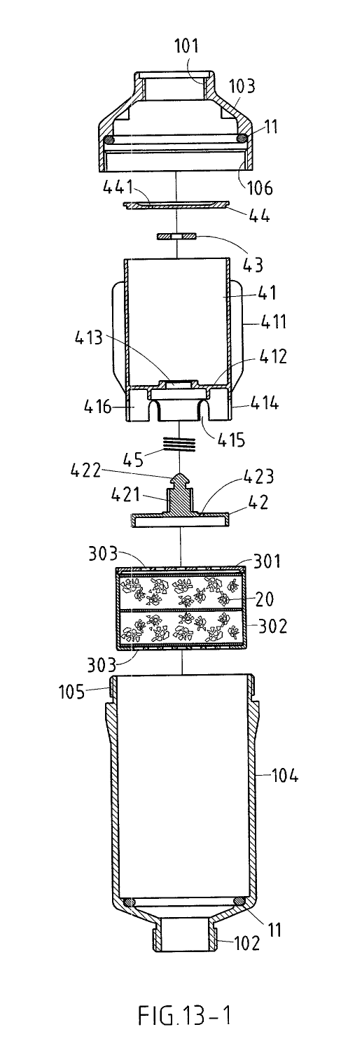

Still another embodiment is seen in FIG. 15. In this embodiment of shower filtration skin care device, a tube (46) may be connected to the center of the bottom of the base plate (412) on the secondary shell (40). Tube (46) connects to the interior of shell seat (41). A bead (461) may be installed in tube (46) so that bead (461) seals the opening at the bottom end oftube (46). When water enters the interior of main shell (10), the water pressure will push bead (461) upward, which in turn will allow the water to flow into the interior of shell seat (41).

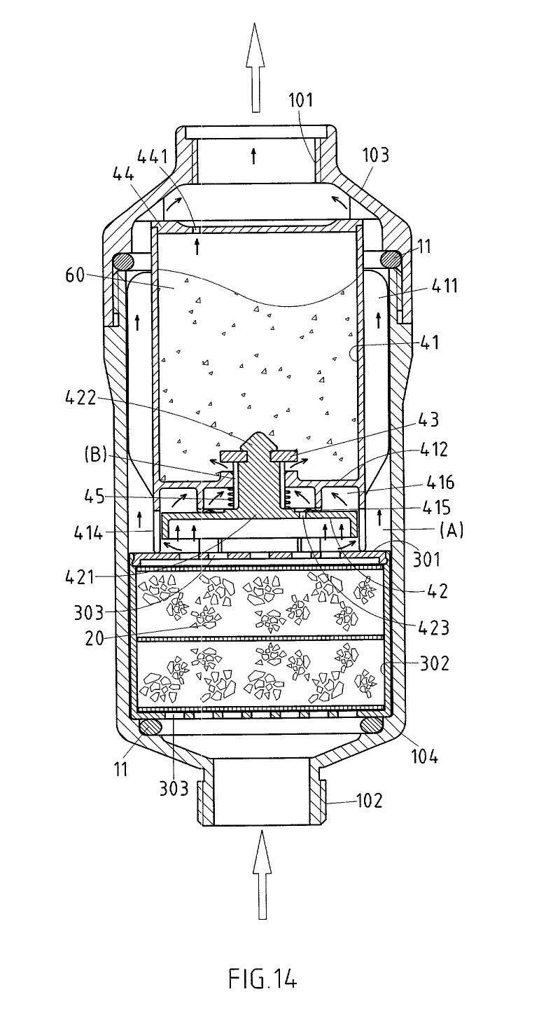

Another embodiment is seen in FIG. 16. In this embodiment of shower filtration skin care device, a tube (46) may be connected to the center of the bottom of the base plate (412) on the secondary shell (40). Tube (46) connects to the interior of shell seat (41). A bead (461) may be installed in tube (46), and the top of bead (461) will hold spring (462) in place, causing bead (461) to be subject to the tension of spring (462) and sealing the opening at the bottom end of tube (46). When water enters the interior of main shell (10), the water pressure will push bead (461) upward, which in turn will allow the water to flow into the interior of shell seat (41).

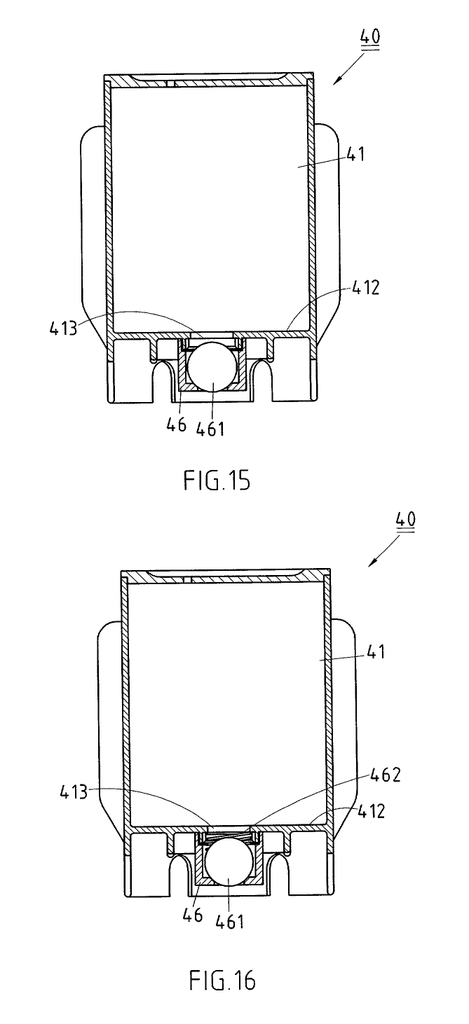

Another embodiment is seen in FIG. 17. In this embodiment of shower filtration skin care device, the base plate (412) of the secondary shell (40) may protrude upward to form a tube (47), in which a bead (471) may be installed. This arrangement causes bead (471) to seal the opening in the tube (47) on the top of base plate (412). When water enters the main shell (10), the water pressure will push bead (471) upward, causing the water to flow into the interior of shell seat (41).

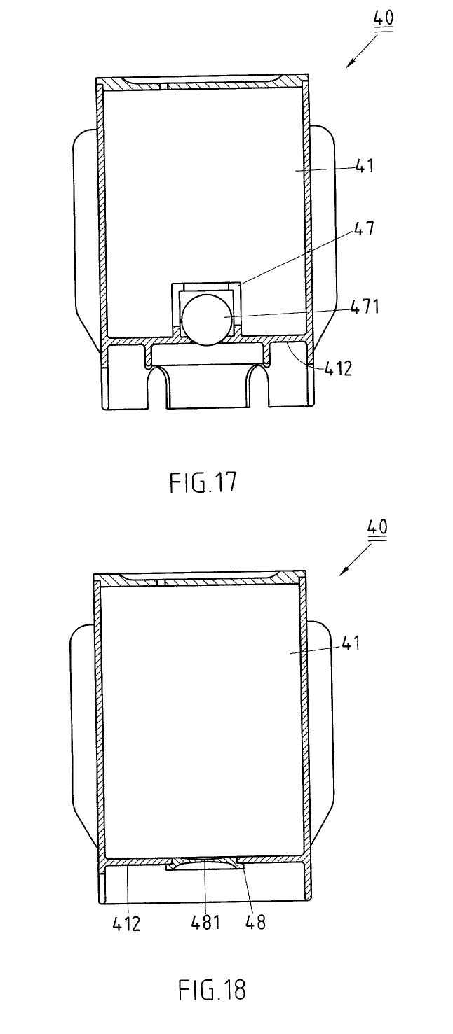

Another embodiment is seen in FIG. 18. In this embodiment of shower filtration skin care device, a backflow valve (48) made of a flexible material may be installed in the center of the base plate (412) on secondary shell (40). The central area of backflow valve (48) is relatively thin, and there is a fine seam (481) in this area. The fine seam (481) is normally in a closed state, but when water enters the main shell (10), the water pressure will push upward and cause the central area of backflow valve (48) to deform, causing the fine seam (481) expand and allow water to flow into the interior of the shell seat (41).

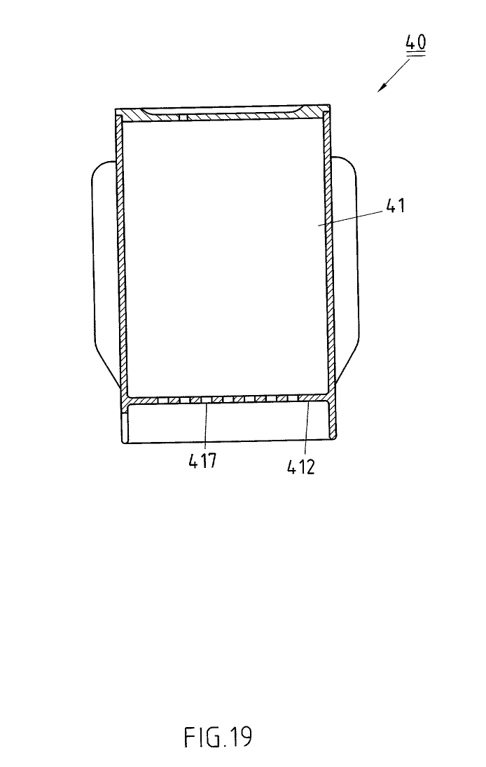

Another embodiment is seen in FIG. 19. In this embodiment of shower filtration skin care device, the base plate (412) of the secondary shell (40) also can form a plurality of water orifices (417) to allow the secondary shell (40) to hold a solid water-soluble granular skin care product (60) for use.

In these embodiments of shower filtration skin care device, the main shell (10), filter seat (30), and secondary shell (40) may be made out of transparent or translucent material.

There are overall advantages of this invention.

First, this invention can be used in conjunction with existing hand-held spray nozzles in household bathrooms. It does not require the replacement of or any structural or external modifications to an existing spray nozzle, and can add a filtration function to an existing hand-held spray nozzle. It thus can improve the quality of the shower water exiting the spray nozzle, while preventing contamination of or damage to skin or hair while showering.

Second, because the main shell (10) is attached to the lower end of an existing hand-held spray nozzle (1), there are no mounting space restrictions, and the assembly is located far from high temperatures at the hot/cold mixing faucet. This assembly is easy to install and use, and offers the practical benefit of not being readily damaged due to high-temperature deformation.

Third, this invention enables the user's skin to contact and derive the therapeutic benefits of skin care products while showering with a hand-held spray nozzle, allowing the user to care for their skin while using a hand-held spray nozzle to shower.

Fourth, this invention refers to a shower filtration skin care device that is convenient to install and use, and whose filtration and skin care process can be readily confirmed by visual inspection.

Fifth, this shower filtration skin care device will be inexpensive to manufacture, and consequently can be sold for a much lower price, while still improving the quality of water from existing hand-held spray nozzles, thereby increasing consumer willingness to purchase the device and encouraging spread of its use.

Finally, because this shower filtration skin care device is light, compact, and easy to carry, a person who is on a trip or traveling abroad may easily carry the device and freely install it on a hand-held spray nozzle found in a hotel room, enabling that person to improve the quality of the shower water, while simultaneously receiving the therapeutic benefits of skin care products when using the spray nozzle to shower.

In summary, this invention is a shower filtration skin care device that has positively achieved the goals of this invention. Since the configuration of spaces in this device's structure has not been seen on any similar product, and has not been made public prior to this application, this invention is nonobvious and has utility and novelty.

The embodiments described above are given only as examples explaining this invention, and are not to be construed as limiting this invention. Anyone familiar with the technical skills involved may, without departing from the spirit of this invention, may perform various types of deformations, decorations, or applications that would in all cases be included within the scope of this invention.

I claim:

1. A shower filtration skin care device comprises of a single locked portion comprising a top and bottom of a main shell, wherein said locked portion can be conjoined to a threaded tube portion at a bottom of an existing hand-held spray nozzle and a threaded orifice at the top end of a nozzle hose, wherein an interior of said main shell forms an appropriate space for installation of a filter body, and wherein a flow of water passes through said main shell and is filtered in said filter body, after which the water is sprayed through said hand-held spray nozzle.

2. The shower filtration skin care device of claim 1, wherein said main shell is comprised of a two-section body, wherein the main shell is divided into an upper and lower cover, and wherein a junction between the upper and lower cover may be either tightly bonded or in the form of locked threaded portions in conjunction with a gasket so as to be suitable for preventing leakage and outflow, while facilitating the installation of filter body in the main shell.

3. The shower filtration skin care device of claim 1, wherein said filter body is comprised of filter cotton, a filter mesh, or a non water-soluble granular or lump-type purification material (such as activated carbon, zeolite, maifan stone, or sulfite, etc.) that can sterilize, deodorize, or soften water.

4. A shower filtration skin care device comprising locking portions formed at a top and bottom of a main shell that can be attached to a threaded tube portion at a bottom of an existing hand-held spray nozzle and a threaded orifice at a top end of a nozzle hose, a filter seat that is installed within said main shell, and a filler body installed within the filter seat, wherein, after water flows through an interior of said main shell and passes through the filter body within filter seat, it is sprayed out via hand-held spray nozzle.

5. The shower filtration skin care device of claim 4, wherein said main shell is comprised of a two-stage body, wherein the main shell is divided into an upper and lower cover, and wherein a junction between upper and lower covers may be locked by means of threaded portions in conjunction with a gasket so as to suitable for preventing leakage and outflow, while facilitating the installation of said filter seat in the main shell.

6. The shower filtration skin care device of claim 4, wherein said filter seat comprises a two-section construction, wherein said filter seat is comprised of upper and lower covers, wherein the upper and lower covers facilitate the installation of a filter body, and wherein a junction between upper and lower covers may optimally be tightly bonded to form a watertight seal.

7. The shower filtration skin care device of claim 4, wherein said filter body comprises filter cotton, a filter mesh, or a non water-soluble granular or lump-type purification material (such as activated carbon, zeolite, maifan stone, or sulfite, etc.) that can disinfect, deodorize, or soften water.

8. The shower filtration skin care device of claim 4, wherein said top and bottom of the filter seat are comprised of numerous screen-covered water orifices.

9. The shower filtration skin care device of claim 4, wherein said outer edge of the filter seat presses tightly against the side wall of the interior of the main shell.

10. A shower filtration skin care device comprising locking portions formed at a top and bottom of a main shell that can be attached to a threaded tube portion at a bottom of an existing hand-held spray nozzle and a threaded orifice at a top end of a nozzle hose, a secondary shell installed within said main shell, and a skin care product placed within the secondary shell, wherein, after water flows through an interior of said main shell and a portion passes through the secondary shell, it is sprayed out via hand-held spray nozzle.

11. The shower filtration skin care device of claim 10, wherein said main shell is comprised of a two-section body, wherein the main shell is divided into an upper and lower cover, and wherein a junction between the upper and lower cover may be locked using threaded portions in conjunction with a gasket, so as to be suitable for preventing leakage and outflow, while facilitating the installation of secondary shell in the main shell.

12. The shower filtration skin care device of claim 10, wherein said secondary shell is comprised of a hollow shell seat, a brake, a water stop flap, an upper cover, and a spring, wherein an external wall of the shell seat is constructed of numerous ribs arranged at intervals so as to insure that after the secondary shell has been placed in the main shell, flow gaps are maintained between the ribs on the exterior of the shell seat and the interior wall of the main shell, wherein a base plate formed near a lower end of the shell seat has a piercing hole in its center, and a base ring seat of suitable length is located around the edge of shell seat below base plate, said edge containing numerous water orifices, forming a suitable space between the base ring seat and the base plate, wherein said brake is a round plate, a central top portion of which protrudes upward to form a column of suitable height, a top of which forms a stop so as to enable an outside of the column to hold a spring, said brake is mounted in the space formed between the base ring seat of the shell seat and the bottom of the base plate, causing the column to pass through a piercing hole in a center of the base plate and enter the interior of the shell seat, and wherein a center of water stop flap is held in place by the stop on the top of the column, insuring that the brake is normally subject to the tension of a spring, and causing column to articulate with water stop flap and seal the central piercing hole in the top of base plate on the shell seat, said suitable gap being maintained between the outer diameter of column and the inner wall of central piercing hole in the base plate, wherein a flow hole perforates a brake near the column and an upper cover can cover the opening in the top of shell seat.

13. The shower filtration skin care device of claim 10, wherein said skin care product placed inside the secondary shell is comprised of water-soluble bath salts, hot springs essence, fragrant essence, emollient liquid, disinfectant, bath balls, bath bars, or perfume.

14. The shower filtration skin care device of claim 10, wherein said surface of the upper cover of secondary shell comprises a water orifice.

15. A shower filtration skin care device comprising locking portions formed at a top and bottom of the main shell that can be attached to a threaded tube portion at a bottom of an existing hand-held spray nozzle and a threaded orifice at a top end of a nozzle hose, a filter seat installed within said main shell, and a secondary shell installed straddling said filter seat, wherein, in this arrangement, after water flows through an interior of said main shell and passes through said filter seat and secondary shell, it is sprayed out via hand-held spray nozzle.

16. The shower filtration skin care device of claim 15, wherein said main shell is comprised of a two-section body, wherein the main shell is divided into an upper and lower cover, and wherein a junction between the upper and lower cover may be locked using threaded portions in conjunction with a gasket so as to be suitable for preventing leakage and outflow, while facilitating the installation of filter seat and secondary shell in the main shell.

17. The shower filtration skin care device of claim 15, wherein said filter seat comprises a two-section manner of attachment, wherein said filter seat comprises upper and lower covers, which facilitate the installation of filter body, and wherein a junction between upper and lower covers may optimally be tightly bonded to form a watertight seal, said surfaces of upper and lower covers being perforated by numerous screen-covered water orifices.

18. The shower filtration skin care device of claim 15, wherein said secondary shell comprises a hollow shell seat, a brake, a water stop flap, an upper cover, and a spring, wherein an external wall of the shell seat is constructed of numerous ribs arranged at intervals so as to insure that after the secondary shell has been placed in the main shell, flow gaps are maintained between the ribs on the exterior of the shell seat and the interior wall of the main shell, wherein a base plate formed near the lower end of the shell seat has a piercing hole in its center and a base ring seat of suitable length is located around the edge of shell seat below base plate, said edge containing numerous water orifices, forming a suitable space between the base ring seat and the base plate, wherein said brake is a round plate, a central top portion of which protrudes upward to form a column of suitable height, the top of which forms a stop so as to enable an outside of the column to hold a spring, said brake being mounted in the space formed between the base ring seat of the shell seat and the bottom of the base plate, causing the column to pass through the piercing hole in the center of the base plate and enter the interior of the shell seat, and wherein a center of water stop flap is held in place by the stop on the top of the column, insuring that the brake is normally subject to the tension of a spring, and causing the column to articulate with the water stop flap and seal the central piercing hole in the top of base plate on the hollow shell seat, said suitable gap being maintained between the outer diameter of column and the inner wall of central piercing hole in the base plate, and wherein a flow hole perforates brake near column and the upper cover can cover the opening in the top of shell seat.

19. The shower filtration skin care device of claim 15, wherein said skin care product placed inside the secondary shell comprises water-soluble bath salts, hot springs essence, fragrant essence, emollient liquid, disinfectant, bath balls, bath bars, or perfume.

20. The shower filtration skin care device of claim 15, wherein said filter body comprises filter cotton, a filter mesh, or a non water-soluble granular or lump-type purification material (such as activated carbon, zeolite, maifan stone, or sulfite, etc.) that can sterilize, deodorize, or soften the water.

21. The shower filtration skin care device of claim 1, wherein said main shell, filter seat, and secondary shell are comprised of transparent or translucent material.

22. The shower filtration skin care device of claim 10, wherein said tube may be connected to the center of the bottom of the base plate on the secondary shell, said tube connecting to the interior of shell seat, wherein a bead may be installed in the tube so that the bead seals the opening at the bottom end of tube and when water enters the interior of main shell, the water pressure will push bead upward, which in turn will allow the water to flow into the interior of shell seat.

23. The shower filtration skin care device of claim 10, wherein said tube may be connected to the center of the bottom of the base plate on the secondary shell, said tube connecting to the interior of shell seat, wherein a bead may be installed in the tube, and the top of bead will hold spring in place, causing bead to be subject to the tension of spring and sealing the opening at the bottom end of tube and when water enters the interior of main shell, the water pressure will push bead upward, which in turn will allow the water to flow into the interior of shell seat.

24. The shower filtration skin care device of claim 10, wherein said base plate of the secondary shell may protrude upward to form a tube, in which a bead may be installed so as to cause the bead to seal the opening in the tube on the top of base plate, and when water enters the main shell, the water pressure will push bead upward, causing the water to flow into the interior of shell seat.

25. The shower filtration skin care device of claim 10, wherein said backflow valve made of a flexible material may be installed in the center of the base plate on secondary shell, said central area of backflow valve being relatively thin, and having a fine seam in this area, wherein the fine seam is normally in a closed state, but when water enters the main shell, the water pressure will push upward and cause the central area of backflow valve to deform, causing the fine seam expand and allow water to flow into the interior of the shell seat.

26. The shower filtration skin care device of claim 10, wherein said base plate of said secondary shell also can form a plurality of water orifices to allow the secondary shell to hold a solid water-soluble granular skin care product for use.
